(19) United States
(12) Patent Application Publication
(10) Pub. No.: US 2013/0040555 A1
(43) Pub. Date: Feb. 14, 2013

(54) ROBUST SPUR INDUCED TRANSMIT ECHO CANCELLATION FOR MULTI-CARRIER SYSTEMS SUPPORT IN AN RF INTEGRATED TRANSCEIVER

(71) Applicants: Roberto Rimini, San Diego, CA (US); Peter D. Heidmann, Encinitas, CA (US); Rajeev Krishnamurthi, San Diego, CA (US); Joseph Patrick Burke, Glenview, IL (US)

(72) Inventors: Roberto Rimini, San Diego, CA (US); Peter D. Heidmann, Encinitas, CA (US); Rajeev Krishnamurthi, San Diego, CA (US); Joseph Patrick Burke, Glenview, IL (US)

(73) Assignee: QUALCOMM INCORPORATED, San Diego, CA (US)

(21) Appl. No.: 13/351,110

(22) Filed: Jan. 16, 2012

Related U.S. Application Data
(60) Provisional application No. 61/523,088, filed on Aug. 12, 2011.

(51) Int. Cl. H04W 4/00; H04K 3/00

(52) U.S. Cl. 455/1

(57) ABSTRACT

A method and apparatus for eliminating transmit echo spurs is provided. The method includes the steps of: estimating a distortion effect applied to a transmit signal by a duplexer stop band. Next, the contribution of a primary component of the spur is estimated. An image component of the spur is estimated after the primary contribution has been estimated. The transmit echo is then subtracted from the composite desired signal by digitally subtracting the distortion effect, the primary component of the spur, and the image component of the spur, producing the desired composite transmit signal without the transmit echo.

### CROSS-REFERENCE TO RELATED APPLICATION(S)

This application claims the benefit of U.S. Provisional Application Ser. No. 61/523,088, entitled “Robust Spurs Induced Transmit Echo Cancellation for Multi-Carrier 3G and 4G Systems Support in RF Integrated Transceiver,” filed on Aug. 12, 2011, which is expressly incorporated by reference herein in its entirety.

### BACKGROUND

1. Field

The present disclosure relates generally to communication systems, and more particularly, to cancelling spur induced transmit echo (Tx-echo) jamming for multi-carrier 3G and 4G system support in an RF integrated transceiver.

2. Background

Wireless communication systems are widely deployed to provide various types of communication content such as voice, data, and so on. These systems may be multiple-access systems capable of supporting communications with multiple users by sharing the available system resources (e.g., bandwidth and transmit power). Examples of such multiple-access systems include code division multiple access (CDMA) systems, time division multiple access (TDMA) systems, frequency division multiple access (FDMA), 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-single-out or a multiple-in-multiple-out (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, where N_{S}_{_{—}}≧min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system may support time division duplex (TDD) and/or frequency division duplex (FDD) systems. In a TDD system, the forward and reverse link transmissions are on the same frequency region so that the reciprocity principle allows the estimation of the forward link channel from the reverse link channel. This enables the base station to extract transmit beamforming gain on the forward link when the multiple antennas are available at the base station. In an FDD system, forward and reverse link transmissions are on different frequency regions.

Modern cellular phones support multiple carriers and modes of operation. In operation multiple synthesizers are turned on at the same time, and each synthesizer is tuned to a specific carrier frequency. Transceiver size is shrinking Internally, this forces the required multiple synthesizers to support multi-carrier operation to be close together, in many cases, within the same RF die.

A drawback of the design is that the close proximity of the multiple synthesizers makes the phone prone to variable oscillator coupling. This coupling may occur through the substrate, or through electromagnetic coupling. The intermodulation products of the local oscillator (LO) non-linearity applied to the two tones signal made of nominal LO plus spur, create many harmonics. It may happen that one of these harmonics falls close to the transmit channel, producing transmit channel reciprocal mixing down to the receiver baseband frequency. This mechanism is referred to as Tx-echo self-jamming. The Tx-echo obscures the desired receive signal and acts as co-channel interference. As a result, conventional filtering using low-pass filters is ineffective.

Other options used to attempt to solve the problem of Tx-echo generation have tried to cure the spur by eliminating it using an analog circuit approach, which requires careful calibration in order to be effective. Other methods have required a look-up table that collects previously analyzed non-linear distortion that arises from well known patterns. The collected distortion patterns in the look-up table are used to transmit a training pattern. This approach requires that an extensive set of training signals be used.

There is a need in the art for mitigating the problem of Tx-echo self-jamming using fully digital linear adaptive cancellation for multi-carrier systems in an integrated RF transceiver.

### SUMMARY

Embodiments disclosed herein provide a method for eliminating Tx-echo self-jamming induced by spurs in the LO path. The method comprises: estimating a distortion effect applied to a transmit signal by a duplexer stop band; estimating a primary component of a spur induced Tx-echo; estimating an additional contribution to the Tx-echo generated by an image component of a spur; and then subtracting the estimated Tx-echo from a composite desired signal by digitally subtracting the Tx-echo distortion effect, made of the primary component of the spur, as well as the image component of the spur.

A further embodiment provides an adaptive filter. The adaptive filter comprises a first processor for estimating a distortion effect applied to a transmit signal by a duplexer stop band and a second processor for estimating a specular contribution to the Tx-echo produced by an image component of a spur and subtracting the combined primary and specular contributions from the Tx-echo signal observed in the receiver path.

A still further embodiment provides an apparatus for eliminating Tx-echo self-jamming induced by spurs. The apparatus comprises: means for estimating a distortion effect applied to a transmit signal by a duplexer stop band; means for estimating a contribution to the Tx-echo produced by the primary component of a spur; means for estimating a specular contribution produced by an image component of the spur; and means for subtracting the estimated Tx-echo from the Tx-echo observed in the receive path by digitally subtracting the reconstructed distortion effects produced by the primary component of the spur and the image component.

An additional embodiment provides a machine readable non-transitory computer-readable medium comprising instructions, which when executed by a processor, cause the processor to perform the steps of: estimating a distortion effect applied to a transmit signal by a duplexer stop band; estimating a contribution to the Tx-echo produced by primary component of a spur; estimating a contribution to the Tx-echo produced by an image component of a spur; and subtracting the combined Tx-echo estimates from a composite desired signal plus Tx-echo by digitally subtracting the estimated Tx-echo distortion effect produced by the primary component of the spur, and the image component of the spur.

### BRIEF DESCRIPTION OF THE DRAWINGS

FIG. 1 illustrates a multiple access wireless communication system, in accordance with certain embodiments of the disclosure.

FIG. 2 illustrates a block diagram of a communication system in accordance with certain embodiments of the disclosure.

FIG. 3 is a diagram illustrating an example of a spur residing in the receiver LO at a frequency near the transmit frequency of the local oscillator in accordance with certain embodiments of the disclosure.

FIG. 4 is a block diagram of a spurious induced Tx-echo linear interference cancellation apparatus in accordance with certain embodiments of the disclosure.

FIG. 5 depicts the spur image effect resulting in the downconversion of the specular receive spectral component for a single carrier.

FIG. 6 illustrates a spurious induced Tx-echo linear interference cancellation apparatus with an image branch in accordance with certain embodiments of the invention.

FIG. 7 is a flow diagram of the operation of the spurious induced Tx-echo linear interference cancellation in accordance with certain embodiments of the disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as, but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to man an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband CDMA (W-CDMA). CDMA2000 covers IS-2000, IS-95 and technology such as Global System for Mobile Communication (GSM).

An OFDMA network may implement a radio technology such as Evolved UTRA (E-UTRA), the Institute of Electrical and Electronics Engineers (IEEE) 802.11, IEEE 802.16, IEEE 802.20, Flash-OFDAM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3^{rd} Generation Partnership Project” (3GPP). CDMA2000 is described in documents from an organization named “3^{rd} Generation Partnership Project 2” (3GPP2). These various radio technologies and standards are known in the art. For clarity, certain aspects of the techniques are described below for LTE, and LTE terminology is used in much of the description below. It should be noted that the LTE terminology is used by way of illustration and the scope of the disclosure is not limited to LTE. Rather, the techniques described herein may be utilized in various application involving wireless transmissions, such as personal area networks (PANs), body area networks (BANs), location, Bluetooth, GPS, UWB, RFID, and the like. Further, the techniques may also be utilized in wired systems, such as cable modems, fiber-based systems, and the like.

Single carrier frequency division multiple access (SC-FDMA), which utilizes single carrier modulation and frequency domain equalization has similar performance and essentially the same overall complexity as those of an OFDMA system. SC-FDMA signal may have lower peak-to-average power ration (PAPR) because of its inherent single carrier structure. SC-FDMA may be used in the uplink communications where the lower PAPR greatly benefits the mobile terminal in terms of transmit power efficiency.

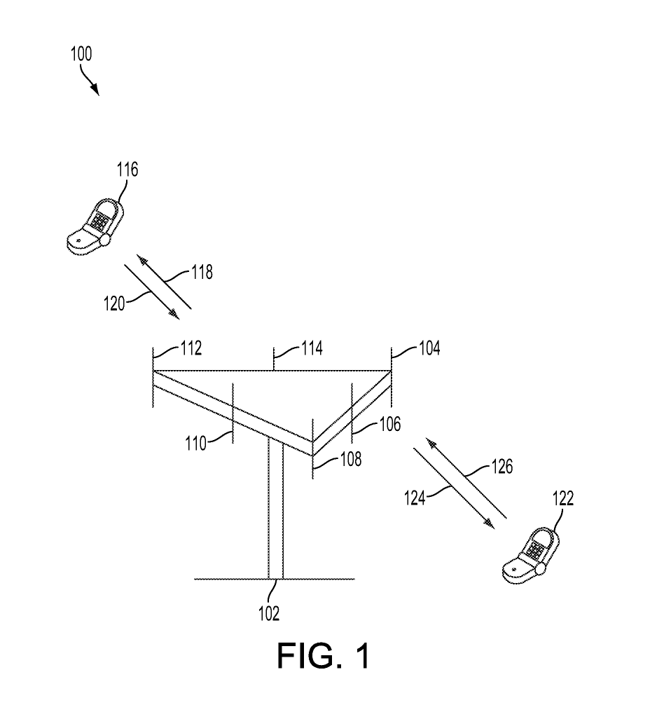

FIG. 1 illustrates a multiple access wireless communication system 100 according to one aspect. An access point 102 (AP) includes multiple antenna groups, one including 104 and 106, another including 108 and 110, and an additional one including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over downlink or forward link 118 and receive information from access terminal 116 over uplink or reverse link 120. Access terminal 122 is in communication with antennas 106 and 108, where antennas 106 and 108 transmit information to access terminal 122 over downlink or forward link 124 and receive information from access terminal 122 over uplink or reverse link 126. In a Frequency Division Duplex (FDD) system, communication links 118, 120, 124, and 126 may use a different frequency for communication. For example, downlink or forward link 118 may use a different frequency than that used by uplink or reverse link 120.

Each group of antennas and/or the area in which they are designed to communicate is often referred to as a sector of the access point. In an aspect, antenna groups each are designed to communicate to access terminals in a sector of the areas covered by access point 102.

In communication over downlinks or forward links 118 and 124, the transmitting antennas of access point utilize beamforming in order to improve the signal-to-noise ratio (SNR) of downlinks or forward links for the different access terminals 116 and 122. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as a Node B, an evolved Node B (eNB), or some other terminology. An access terminal may also be called a mobile station, user equipment (UE), a wireless communication device, terminal, or some other terminology. For certain aspects, either the AP 102, or the access terminals 116, 122 may utilize the proposed Tx-echo cancellation technique to improve performance of the system.

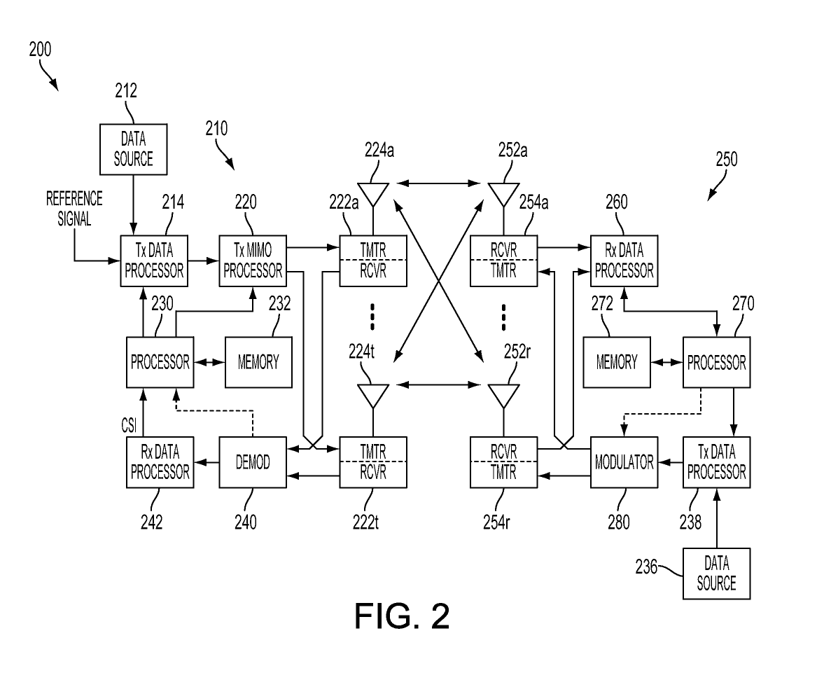

FIG. 2 is a block diagram of an aspect of a transmitter system 210 and a receiver system 250 in a MIMO system 200. At the transmitter system 210, traffic data for a number of data streams is provided from a data source 212 to a transmit (TX) data processor 214. An embodiment of the disclosure is also applicable to a wireline (wired) equivalent of the system shown in FIG. 2.

In an aspect, each data stream is transmitted over a respective transmit antenna. TX data processor 214 formats, codes, and interleaves the traffic data for each data stream based on a particular coding scheme selected for that data stream to provided coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular based on a particular modulation scheme (e.g. a Binary Phase Shift Keying (BPSK), Quadrature Phase Shift Keying (QPSK), M-PSK in which M may be a power of two, or M-QAM, (Quadrature Amplitude Modulation)) selected for that data stream to provide modulation symbols. The data rate, coding, and modulation for each data stream may be determined by instructions performed by processor 230 that may be coupled with a memory 232.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by the N_{R} antennas 252a through 252r and the received signal from each antenna 252 is provided to a respective receiver (RCVR) 254a through 254r. each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX processor 260 is complementary to that performed by TX MIMO processor 220 and TX data processor 214 at transmitter system 210.

Processor 270, coupled to memory 272, formulates a reverse link message. The reverse link message may comprise various types of information regarding the communication link and/or the received data stream. The reverse link message is then processed by a TX data processor 238, which also receives traffic data for a number of data streams for ma data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240 and processed by a RX data processor 242 to extract the reserve link message transmitted by the receiver system 250.

Certain embodiments of the disclosure propose a method for mitigating transmit reciprocal mixing, or Tx-echo, produced by an undesired spurious falling in the receive local oscillator path at a frequency near that of the transmit local oscillator. The proposed method uses a reconstruction of the interference created with digital adaptive techniques. The reconstruction is then cancelled out from the corrupted receive signal. The transmit signal used for the reconstruction is already known and has different statistical properties with respect to the desired receive signal. The method is known as spurious linear interference cancellation (SLIC).

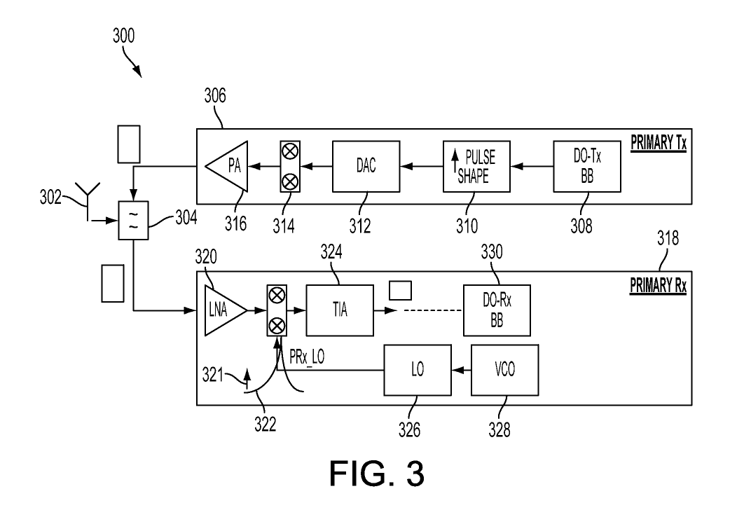

FIG. 3 illustrates a block diagram of an RF integrated transceiver, 300. The assembly, 300, is comprised of both transmit and receive elements. An antenna, 302, is used to transmit signals over the air after the signals are prepared by the primary transmission chain 306. The antenna 302 is connected to a transmit/receive duplexer 304, that enables transmitting and receiving simultaneously. The transmission chain 306 prepares the signal for transmission by the antenna 302. The first step in preparing the transmission signal is performed by the transmit digital modulator 308 that initiates a baseband signal.

This baseband signal is passed to the pulse shaper 310 that shapes the digital modulator 308 output. After being shaped by the pulse shaper 310, the signal is passed to the digital to analog converter 312. From the digital to analog converter 312 the signal is passed to a mixer 314, which is a local oscillator mixer. The mixer 314 prepares the signal to be amplified by the power amplifier 316. Once the signal has been amplified it is sent to the transmit/receive duplexer 304. From the transmit/receive duplexer 304, the transmission signal is passed to the antenna 302, which transmits the signal.

Transmit/receive duplexer 304 also interfaces with a primary receive chain 318. In operation, a signal is received at antenna 302 and is passed to the transmit/receive duplexer 304. The first step in the primary receive chain 318 processing occurs at the low noise amplifier, 320. The low noise amplifier amplifies a weak signal and assists in preparing the signal for further processing by the mixer 322. Mixer 322 mixes the signal from the low noise amplifier with the local oscillator 326 input and variable control oscillator (VCO) 328. The variable control oscillator 328 sends an input to the local oscillator 326. This signal is sent from the local oscillator 326 to the mixer 322.

From the mixer 322, the signal is passed to the trans-impedance amplifier for further amplification. The resulting signal is then passed to the digital baseband chain 318.

Spurs 321 are created by undesired coupling of VCOs located in the same transceiver and may fall in the receive LO at a frequency nearby the transmit LO frequency thus generating transmit reciprocal making in the receiver. The location of spurs can be predicted by a priori.

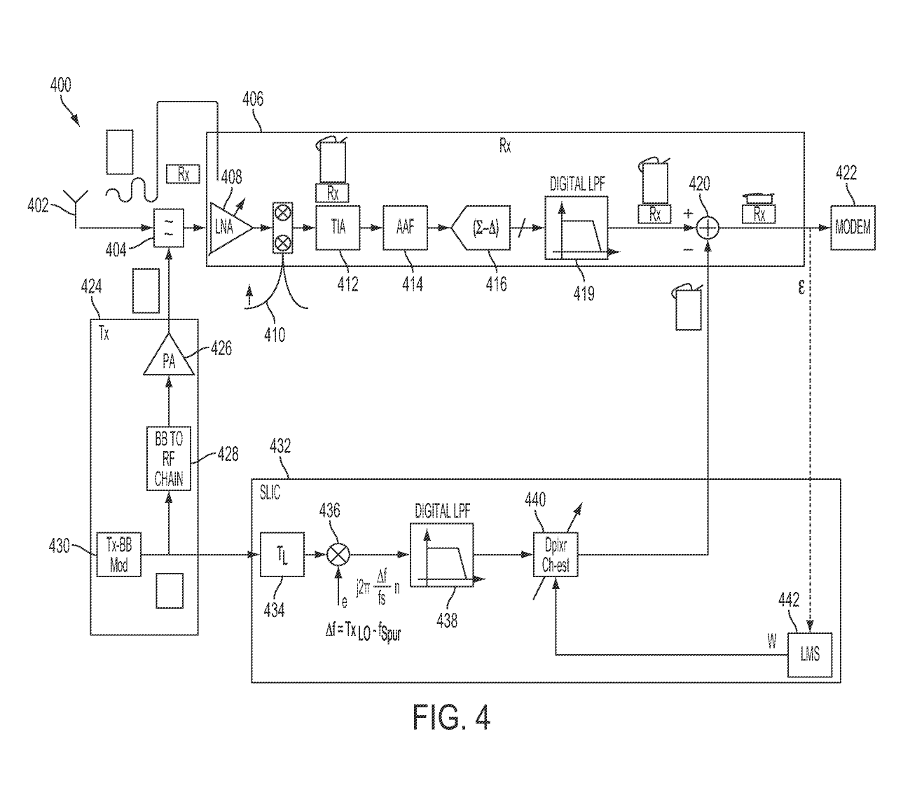

FIG. 4 illustrates in block diagram form an assembly for an RF integrated transceiver 400 with an adaptive spurious linear interference cancellation (SLIC) incorporated. The system 400 includes an antenna 402 for transmitting and receiving signals. The transmit chain 424 prepares signals for transmission by the antenna 402. The receive chain 406 receives and processes the signal in conjunction with the SLIC apparatus 432. The receive chain 406 begins when antenna 402 receives a signal made of desired signal plus Tx-echo from spur reciprocal mixing. In the receive chain, the signal is first passed to the variable low noise amplifier 408 for amplification of weak signals. The variable lower noise amplifier 408 then passes the received signal to the mixer 410. The mixer 410 passes the signal to the transient impedance amplifier 412 for further amplification. The resulting signal is then sent to anti-aliasing filter 414 to remove alias products. Anti-aliasing filter 414 then passes the signal to the analog to digital converter 416, which converts the analog receive signal to digital form for further processing. After conversion, the signal is further filtered by a digital low pass filter 418. This signal is then sent to a digital summer, 420. Digital summer 420 also receives input from the SLIC processing chain 432, discussed in more detail below. The digital summer 420 combines the SLIC 432 output with the output of the digital low pass filter 418 and sends the residual signal after subtraction to the modem 422.

Transmit chain 424 begins the generation of a broadband signal. The transmit signal is prepared by the transmit baseband modulator 430. The resulting signal is then fed to the baseband to RF chain 428 for upconversion to RF frequency. The resulting signal is then fed to the power amplifier 426, which amplifies the signal prior to transmission to the duplexer 404 and antenna 402. Transmit baseband modulator 430 also provides an input to the SLIC 432. The input from the transmit baseband modulator 430 is provided to the SLIC 432 after appropriate delay generated by the buffer transmit 434. The buffer transmit 434 provides input to nominal controlled oscillator (NCO) 436, which applies the difference in frequency, Δf between the frequency of the transmit local oscillator 434 and the frequency of the undesired spur. The frequency shifted signal is then passed to a digital low pass filter 438 for filtering to retain the portion falling in the receiver channel. The filtered output is then sent to the adjustable duplexer and channel estimator, 440. The adjustable duplexer and channel estimator also receives input from the LMS 442. The resulting output of the adjustable duplexer and channel estimator 440 is sent from the SLIC 432 to the algebraic summer 420 in the receive chain for additional processing.

The method of spur induced Tx-echo cancellation requires estimating: (1) the distortion effect applied to the transmit signal by the duplexer; and (2) the contribution to the Tx-echo produced by the image component of the spur. This method is illustrated above in FIG. 4. The transmit side is depicted at the left side of the figure, the receive side is seen at the top of the figures, and the spurious linear interference cancellation (SLIC) is seen at the bottom of the figure. The transmit and receive sections are separated by the duplexer, which appears as a non-flat response in the stop band.

In operation, the method of robust spur induced Tx-echo cancellation first spills out the I and Q samples from the modulator 430 and feeds them into the SLIC 432. The SLIC is composed of an adaptive filter 438 and duplexer channel estimator 440 that adaptively reconstructs the distortion added to the transmit signal by the duplexer stop band ripples. The coefficients of the adaptive filter are then adaptively computed based on mean square error. Two adaptive filters are used in parallel to simultaneously reconstruct and subtract both the positive and the negative frequency image of the Tx-echo.

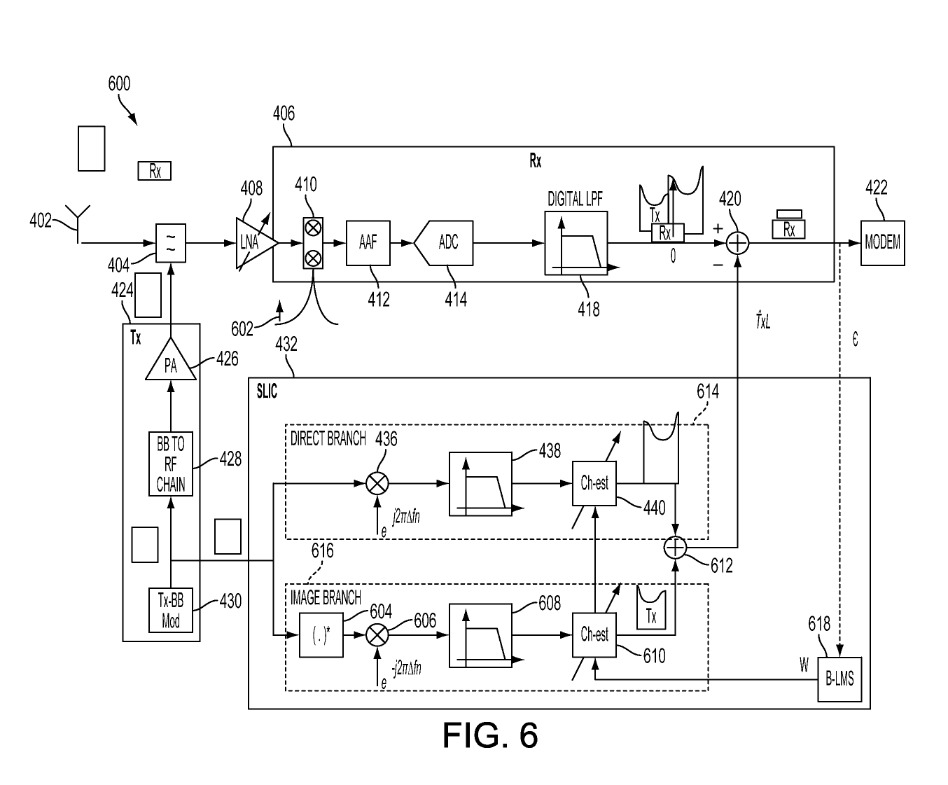

Spurs do not exist only as discrete spikes or disruptions to a signal. A spur may also have a significant image component in the negative frequency as well. The spur comes with its own image and as a result there is now a primary Tx-echo and an image Tx-echo. Both must be canceled, which requires two filters, as described above. A conjugate operation, in the time domain corresponding to reversing the spectrum is used in conjunction with the image branch of FIG. 6 to estimate the specular portion of the Tx-echo generated by the spur image component.

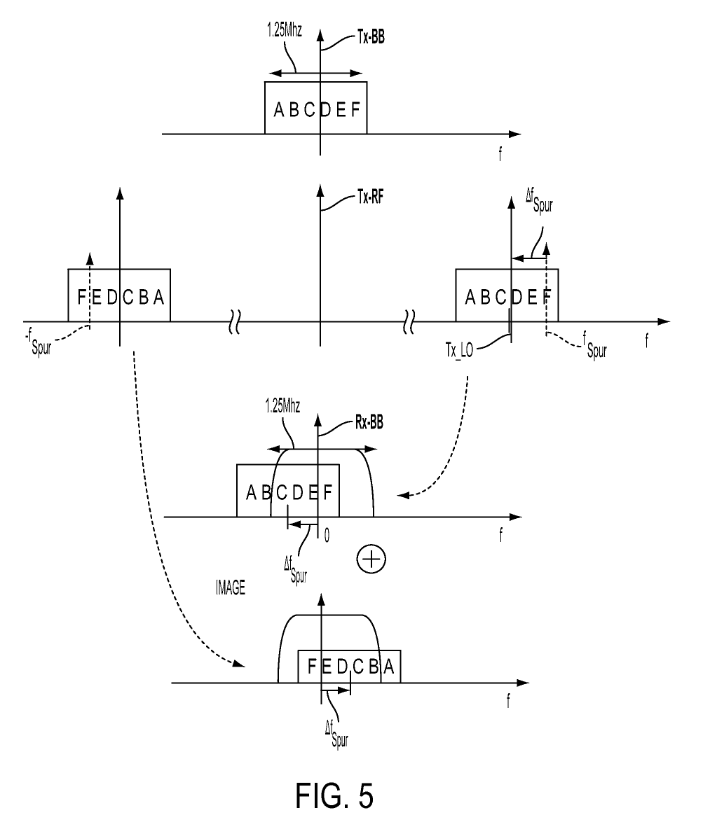

FIG. 5 provides an illustration of the spur image effect for a single carrier. The presence of the spur image component results in the reciprocal mixing with the negative side of the transmit spectrum. The overall Tx-echo signal observed at the receiver baseband is then composed of the superposition of the two down-converted transmit spectrum: both positive and negative. This is like having two echoes superimposed.

In order to achieve good echo cancellation both the primary and the image portion of the Tx-echo must be reconstructed. Given that the magnitude and phases are unknown, two adaptive filters are needed while still performing the weight adaptation using a single loop. This is illustrated in FIG. 6, which is discussed in detail below. The output from each adaptive filter is combined to produce the composite Tx-echo (primary plus image) which is then subtracted from the composite Tx-echo receive signal.

FIG. 6 illustrates in block diagram form a spurious linear interference cancellation apparatus 600 with direct branch 614 and image branch 616 for use with an RF integrated transceiver. The apparatus 600 includes an antenna 402 for transmitting and receiving signals. The receiver chain 406 receives and processes signals by the antenna 402. The receive chain 406 begins when antenna 402 receives a signal and passes it to the transmit/receive duplexer 404. In the receive chain, the signal is first passed to the low noise amplifier 408 for amplification of weak signals. The low noise amplifier 408 then passes the received signal to the mixer 410. The mixer 410 passes the signal to the anti-aliasing filter 412 to remove alias products. Anti-aliasing filter 412 then passes the signal to the analog to digital converter 414, which converts the analog receive signal to digital form for further processing. After conversion the signal is further filtered by a digital low pass filter, 418. This signal is then sent to a digital summer 420. Digital summer 420 also receives input from the SLIC processing chain 432, discussed in more detail below. The digital summer 420 combines the SLIC output 432 with the output of digital low pass filter 418 then sends the signal to the modem 422.

Transmit chain 424 begins with the transmit signal being prepared by the transmit baseband modulator 430. The resulting signal is then fed to the RF chain 428 for upconversion to RF frequency. The resulting signal is then fed to the power amplifier 426, which amplifies the signal prior to transmission to the duplexer 404 and antenna 402. Transmit baseband modulator also provides an input to the SLIC 432. The input from the transmit baseband modulator is provided to both the direct branch 614 and the image branch 616 of the SLIC 432. This input is provided to NCO 436 in the direct branch 614. The NCO 436 applies the difference in frequency, Δ f between the frequency of the desired frequency and the undesired spur 602 to account for separation between the spur and transmit LO. The combined signal is then passed to a digital low pass filter 438 for filtering. The filtered output is then sent to the channel estimator 440.

The image branch 616 operates in a similar fashion to the direct branch 614. The image branch input is routed first to a conjugate COMPONENT 604 that applies a conjugate operation to create the specular component of the Tx-echo. COMPONENT 604 passes the output to NCO 606. NCO 606 also applies the difference in frequency Δ f between the frequency of the transmit LO and the frequency of the undesired spur 602. The output of each adaptive channel estimator is then sent to summer 420 in the receive chain to remove the Tx-echo interferences. The output 420 is sent to the B-LMS 618 for additional processing to update the coefficient of each channel estimator.

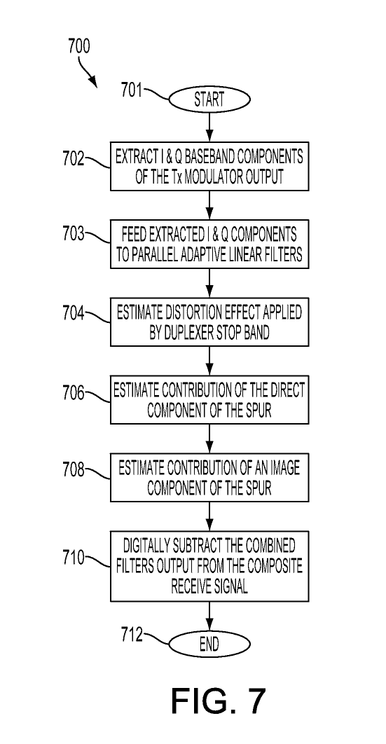

FIG. 7 describes a method 700 for performing SLIC processing. The method begins at the start block 701. In step 702 the I and Q baseband components of the transmit modulator output are extracted. In step 703 the I extracted I and Q components are fed to parallel adaptive linear filters. The output of the adaptive linear filters are input to step 704, where the distortion effect applied by the duplexer stop band can be estimated. The next step 706 provides for the estimation of the contribution to the Tx-echo produced by the primary component of the spur be estimated. In step 708 an estimate of the contribution to the Tx-echo produced by an image component of the spur is estimated. With the estimates computed in steps 704, 706, and 708 completed, the next step 710 provides that the combined filters output be digitally subtracted from the composite receive signal, corrupted by Tx-echo. This results in a signal that has a significant portion of the Tx-echo removed from the designed receiver signal.

In operation the method first spills out the I and Q samples from the modulator and feeds them into the SLIC. The SLIC is composed of an adaptive filter (duplexer channel estimator) that adaptively reconstructs the distortion inferred to the transmit signal by the duplexer stop band ripples. The coefficients of the adaptive filter are then adaptively computed based n the mean square error. Two adaptive filters are used in parallel to simultaneously reconstruct and subtract both the direct Tx-echo and the secular component of the Tx-echo produced by the image of the spur.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for eliminating local oscillator (LO) spurs induced transmit echo self-jamming the receive path, comprising:
estimating a contribution to the transmit echo produced by a primary component of a spur;
estimating a specular contribution to the transmit echo produced by an image component of the spur;
estimating a linear distortion effect applied to a transmit leakage signal by a duplexer stop band associated with the primary and image components of the spur;
subtracting the combined estimated transmit echo linear distortion from the receive signal corrupted by spur induced transmit echo by digitally subtracting the estimated primary component of the transmit echo and its specular component wherein each component includes the duplexer linear distortion reconstruction.

2. The method of claim 1, wherein the subtracting the estimated transmit echo from a receive signal corrupted by transmit echo self-jamming by digitally subtracting the estimated linearly distorted transmit echo effect produced by the primary component of a spur only.

3. The method of claim 1, wherein the subtracting of the estimated linearly distorted effects produced by the primary and the image components of a spur occurs in parallel.

4. The method of claim 1, wherein the estimation of the transmit direct and specular echo components does not include the linear distortion estimation produced by the RF filter.

5. The method of claim 1, further comprising computing a baseband equivalent frequency offset of the self-jamming transmit echo and applying the same computer frequency offset to the estimated-transmit echo before subtraction from the composite received signal.

6. An adaptive filter, comprising:
a first processor for estimating a distortion effect applied to a transmit signal leakage by a duplexer stop band associated with the primary component of the spur;
a second processor for estimating the specular distortion effect applied to a transmit signal leakage by a duplexer stop band associated with the image component of the spur.

7. The adaptive filter of claim 6, wherein the residual error after cancellation is fed back to estimate the weights of the adaptive linear filters.

8. The adaptive filter of claim 6, further comprising a third processor for estimating weights for the adaptive filters associated with both spurs component based on mean square minimization.

9. An apparatus for eliminating transmit echo spurs, comprising:
means for estimating a distortion effect applied to a transmit signal by a duplexer stop band;
means for estimating a contribution of a primary component of a spur;
means for estimating a contribution of an image component of the spur;
means for subtracting the transmit echo from a composite desired signal by digitally subtracting the distortion effect, primary component of the spur and the image component.

10. The apparatus of claim 9, further comprising means for subtracting the transmit echo from a transmit signal by digitally subtracting the distortion effect before the subtraction of the image component.

11. The apparatus of claim 9, wherein the means for subtracting the distortion effect and the means for subtracting the image component operate in parallel.

12. The apparatus of claim 9, further comprising means for computing a frequency offset and means for imputing the computed frequency offset to the transmit echo before the means for subtraction from the composite signal operates.

13. A machine readable non-transitory computer-readable medium comprising instructions, which when executed by a processor cause the processor to perform the steps of:
estimating a distortion effect applied to a transmit signal by a duplexer stop band;
estimating a contribution of a primary component of a spur;
estimating a contribution of an image component of the spur;
subtracting the transmit echo from a composite desired signal by digitally subtracting the distortion effect, primary component of the spur and the image component.

14. The machine readable non-transitory computer readable medium of claim 13, further comprising instructions for subtracting the transmit echo from a transmit signal by digitally subtracting the distortion effect before the subtraction of the image component.

15. The machine readable non-transitory computer readable medium of claim 13, further comprising instructions for subtracting the distortion effect and the image component in parallel.

16. The machine readable non-transitory computer readable medium of claim 13, further comprising instructions for computing a frequency offset and inputting the computed frequency offset to the transmit echo before subtraction from the composite desired signal.
